(19) United States
(12) Patent Application Publication
(10) Pub. No.: US 2007/0105627 A1
(43) Pub. Date: May 10, 2007

(54) Mobile game or program distribution

(76) Inventor: Thomas Robert Garratt Campbell, London (GB)

Correspondence Address: DRUMMOND & DUCKWORTH, Suite 500, 4590 MacArthur Blvd., Newport Beach, CA, 92660, US

(21) Appl. No.: 11/588,550

(22) Filed: Oct. 27, 2006

(30) Foreign Application Priority Data
Oct. 29, 2005 (GB) GB 0522079.3

(51) Int. Cl. A63F 13/00

(52) U.S. Cl. 463/40

(57) ABSTRACT

A person to person mobile phone game distribution service allows a person 1 who has a mobile phone game or other application 2 installed on their phone 3 to send the game to someone else 4 mobile phone 5 by building into the game the ability to send a link via the phone messaging 6 using SMS, MMS or other messaging protocol. The second person 4 can then play game 7 or a demo, full, time limited, or pay per play version of the game. The second person can also request via the game using the phone messaging a full version of the game to be installed on their phone 8 which they are then charged for.

### BACKGROUND OF THE INVENTION

This invention relates to distribution of games or other programs or data using mobile terminals, such as mobile telephones, PDAs, mobile computer or other mobile means. The term handset or phone encompasses all of these.

Mobile phones are commonly used nowadays for many other purposes than simply making and receiving telephone calls. In addition, to text/email/instant messaging services, they are often used to play games on or computer programs of many different types may be used on various phone operating systems. Conventionally, the supplier of a game or other program or application to be run on a mobile phone platform has to provide the game for download on a server or distribution network and must of course advertise the game in order to be able to find custom to buy the game or perhaps to download trial versions with the aim of them being happy with it and ultimately purchasing the game or a licence.

The present invention arose in an attempt to provide an improved method for distributing mobile games or other applications.

### SUMMARY OF THE INVENTION

According to the present invention there is provided a system for distributing software between mobile terminals on a wireless network, comprising a first mobile terminal, at least one further mobile terminal and a data server all connected over the network, wherein the first mobile terminal includes means for storing and running a software application, means for transmitting a link to a location on the server which stores the software or related software, to the second terminal and the second terminal contains means for using the link to download the software or related software.

In a further aspect, the invention provides a method of distributing software applications between mobile terminals on a wireless network, the method comprising transmitting, software application to a first terminal, the application including a link or means for generating a link to a location on a server where the software or related software is located, causing the first terminal to transmit the link to one or more second terminals and using the link received at the or each second terminal to download the software or related application to the or each second terminal from the server.

The application downloaded to the second terminal is a full application, or alternatively, it might be a modified version, such as a demonstration version, time limited version, pay per play version or other.

Preferably, the link points to a J2ME JAD file that itself references a JAR file that allows the software to load directly into the second terminal's software install sub-system.

Preferably, as a software application is distributed, an embedded identification code is added to the software, enabling tracking of the route of distribution.

Preferably, the link message is dispatched to one or more second mobile terminal when the application is run on the first terminal or at a point during operation of the program.

The link may be sent to each or selected ones of contact stored on the first terminal.

The invention further provides a mobile game distribution system allowing the user of one mobile terminal to transmit a software application to a further mobile terminal by means of the software application being adapted to cause or enable the first mobile terminal to transmit a message, containing a link to a location on a server which stores the software application or a related application, to one or more further mobile terminals.

Preferably, this is done at the time of running the software application or at a point during operation of the applications.

The software application may alternatively be transmitted directly from a first to one or more second terminals when the application is run.

In further aspects, the invention provides, as non-limiting examples, the following features:
A. A mobile phone game distribution system that allows someone to send a game to another person's phone by the game sending a message containing a link to download the game.
B. A mobile phone game distribution system where the game is sent directly from the first to the second phone and not via a link to a download server.
C. The link means point to a JAD (eg J2ME JAD file) file that itself references a JAR file that allows the game to load directly into the phones software install subsystem.
D. An embedded identification code may be added to the game as it is distributed thus allowing the tracking of the distribution route.
E. The tracking information may then used to reward the player for recruiting new players.
F. The message is sent as part of the game play.
G. The fact that a message has been sent and a game loaded onto a new phone may give the player extra capabilities within the game.
H. The fact that a message has been sent and a game loaded onto a new phone may be a key strategy to wining the game.
I. On sending a game the second player (user of the second terminal) may be added to the first player's team or list of opponents so they can then play cooperatively or against each other using the games multi player features.
J. Purchase of the full version of the game may subscribe the purchaser to an ongoing subscription that is automatically charged.

Although primarily intended for games, of course where the term ‘game’ is used herein this may alternatively be any other software application.

### BRIEF DESCRIPTION OF THE DRAWINGS

Embodiments of the invention will now be described, by way of example only, with reference to the accompanying drawings, in which:

FIG. 1 shows schematically part of a mobile telephone system;

FIG. 2 shows schematically a viral distribution; and

FIG. 3 shows a sequence diagram of the transmission of a software application.

### DETAILED DESCRIPTION OF THE INVENTION

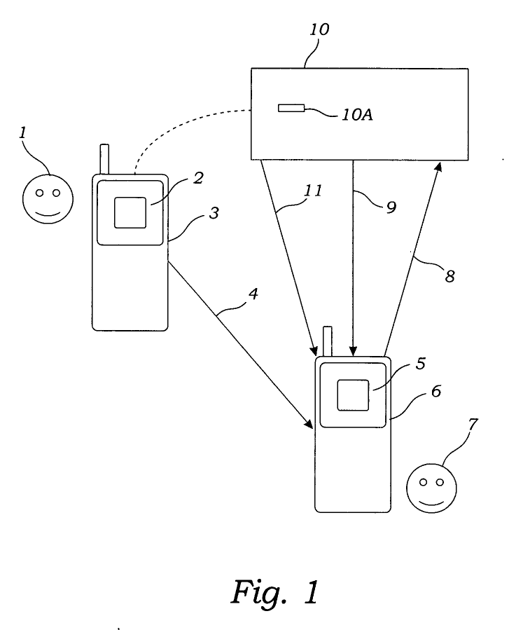

Referring to FIG. 1, a first user 1 has a mobile phone or other handheld terminal (PDA, handheld computer, etc) upon which is installed a game or other software application. The game might have been downloaded initially from a data server 10 or from a different location. The game includes an option of sending a link to the location 10a on the server where the game or a related game is stored and to send this link to another mobile terminal owned by user 7. The link may be sent via the phones in-built messaging application which might include, for example, SMS (text messaging), ESMS, MMS, email, instant messaging or other messaging protocols. It may also include, for example, Bluetooth transmission or other direct or indirect wireless transmissions such as Wi-Fi™ or others. When the user 7 of the further handset 6 receives the message, it can select the link in the normal way and this then causes the game or other application to be downloaded over link 11 from the location 10a on the server 10. The terminals will normally be connected to the server via cellular telephone technology over a wireless network. The game can then be played by the user of terminal 6.

Most preferably, the game is one which requires purchase and so before the user 7 can play it he needs to purchase the game. Methods for enabling purchase of ‘mobile’ games, etc are well-known such as premium SMS charging services, credit card payment systems and so on. In other versions, the version of the game downloaded to handset 6 may be a demonstration (demo) version which enables a user to play certain features of the game for free or which perhaps enables him to use the full game for a time limited period. The version may alternatively be one why the user pays each time he plays the game.

If a limited version of the game is initially downloaded, then the user of the handset 6 may also request, via this limited game, and using the phone's messaging system, a full version of the game to be installed on their phone and they are then charged for the full version.

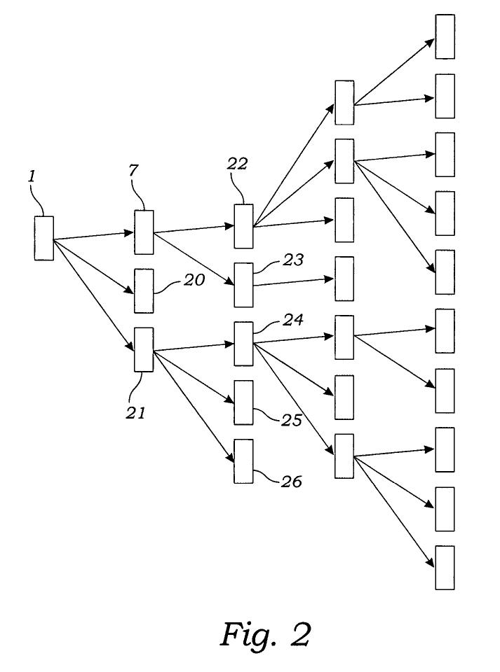

User 1 can choose to send the game to any one other user 7 or to many users, typically he will select these from a contact list or address book which he has pre-stored on his phone. The links may be sent to all recipients simultaneously, or sequentially. Similarly, user 7 can then also forward a link to the game on to any of his contacts. In this way, as is shown schematically in FIG. 2, the game, or at least links to it, may then be transmitted to many users. As shown schematically, user 1 transmits a link to the game to users 7, 20 and 21. User 7 might then transmit the game to users 22 and 23, user 21 might not transmit the game and user 21 might then transmit it onto users 24, 25 and 26 and so on. In the way, the game or other software application is ‘virally’ transmitted to many users. Even if the game is a demo version which is transmitted, the likelihood is that at least some of the users will try the demo version and will like it sufficiently to want to purchase the full product. Thus, in addition to its technical effects of enabling efficient distribution of software applications between handsets, the application may also increase the revenue of the provider of the game or other application.

Reverting to FIG. 1, a demo version of the game is downloaded by the user of terminal 6. If the user enjoys the demo version and requires the full version, he sends a message 8 to the server which then replies by downloading the full version of the game over message channel 9.

The game may be one based on the Java J2ME platform which is known in itself. This can be distributed to Java enables mobile phones and nowadays many phones are Java enabled. The first customer 1 buys the game and downloads the full version to his handset 2. Most preferably, as part of the download, the JAD file of the game is updated to indicate the order ID of the customer making the download. The game includes a ‘send game to friend’ option. If the user 1 selects this option, then this will, in one embodiment of the invention, sends a mobile originated SMS message to a selected friend or more than one selected friend, containing a download URL or link to a demo version of the game and includes the order ID of the original game. When the second customer receives this message, he selects the downloaded URL (typically by clicking it) and this generates a HGTP request to the viral download server 10. The server determines by looking at parameters on the URL that a new customer wants to download a demo version of the game and creates a ‘viral’ record in the database. In doing this, it fills in as much information as is known about the new customer, such as telephone number and any other data it may have about that customers from the known subscription. This new order is then linked to the original order ID (of the first user) using the order ID parameter in the URL. The server then returns the new demo version of the game to the user. The second user 7 can then play the game either for a time limited period or as a restricted version, until the demo version expires and may at that time, or before, have the option of purchasing a full version of the game.

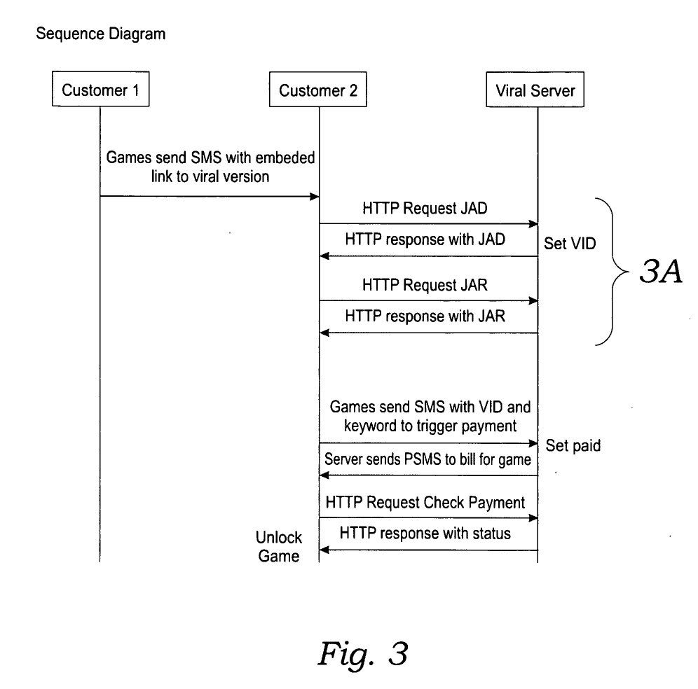

If the user chooses to purchase the full game, then the game is adapted to send an SMS message, including a keyword, a product code and viral order ID to the server. The server then sends a premium billing SMS message to the customer. The server also sends a WAP push message to the customer including the download URL of the full game. The user then selects this download and this returns a JAD file to the customer. The JAD will have been re-written by the server to include order-specific JAR URLs and other information. The server updates the viral order with the information that this is complete. Use of the JAD file on the customer's phone initiates the download of a JAR file from the server. This process is shown in part 3a of FIG. 3.

Optionally (part 3b or FIG. 3), the full version can be purchased by the game being arranged, upon being played by customer 2, to send an SMS message, including a keyword, a product code and a viral order ID (VID) to the server. The server then sends a billing SMS message back to the phone. At this stage the game is aware that the customer has requested to pay because he has sent the initial SMS but is not aware that the billing message has arrived as it does not have direct access to messages arriving on the phone. Therefore, the game might or might not be enabled yet. Then, each time the game is started, it polls the server (HGDP request check payment) to check whether the viral order ID has been paid. The server replies with HGTP response indicating the state. If the payment has not yet been made, then the demo version of the game continues. If the payment has been made then the full version of the game will be enabled or perhaps can be downloaded.

In an alternative method, the game may be arranged to send an SMS message including a keyword, product code and viral order ID to the server. The server sends a premium SMS back to the customer. This SMS may optionally include an activation ID as a human-readable piece of text in the text message, for example a string of numbers or alphanumeric numerals. The customer must then enter this activation ID manually into the game in order to manually enable the game.

Other features which may optionally be provided are as follows:
The phones may connect to each other directly, for example via Wi-Fi, Bluetooth or indeed by direct cable connection (or via a messaging server) to send/receive links.

In other embodiments, the game or part thereof may be downloaded from one mobile phone to another directly instead of via the server.

The sending of a game to another user can be optionally incorporated into game play itself so that, for example, once the game player reaches a particular level or gains a predetermined number of points he has the option of sending the game to other players. This may act as incentive to recruit other players.

In further embodiments, an identification code might be embedded in each installed version of the game. This might be sent in all messages and attached to all URLs and thus can be used to identify all games sent by a particular individual in addition to all games send by people who receive the game from that individual and so on. This data can then be used to indicate the precise distribution route and how efficiently the distribution system is being used. It enables the routes that a particular instance of the game uses to be trapped and this might optionally be incorporated into the game play by giving a player extra capabilities in the game depending upon how many people they recruit as players. Furthermore, players might be given credits might enable them to reduce the cost of future game purchases or subscriptions, if they recruit certain numbers of new players.

Note that in embodiments of the invention, it is the customer who in effect pays for the advertising by sending the games to his friends, the customer is paying the price of sending one standard text message, where SMS is used. Furthermore, the user will generally send a message to people on his contact book and is likely to be in the contact book of the recipient, then the text messages ‘from address’ is the phone number of a ‘trusted’ recipient and that recipient is more sure that the message is not simply spam or unwanted and this also adds a degree of recommendation to the transmission. In effect, once a first sale has been conventional (download from server 10 to terminal 2) then file distribution and hopefully sales occur virally without significant further cost of distributor, by means of ‘viral’ transmission.

1. A system for distributing software between mobile terminals on a wireless network, comprising a first mobile terminal, at least one further mobile terminal and a data server all connected over the network, wherein the first mobile terminal includes means for storing and running a software application, means for transmitting a link to a location on the server which stores the software or related software, to the second terminal and the second terminal contains means for using the link to download the software or related software.

2. A method of distributing software applications between mobile terminals on a wireless network, the method comprising transmitting, software application to a first terminal, the application including a link or means for generating a link to a location on a server where the software or related software is located, causing the first terminal to transmit the link to one or more second terminals and using the link received at the or each second terminal to download the software or related application to the or each second terminal from the server.

3. A method as claimed in claim 2, where the application downloaded to the second terminal is a modified version.

4. A method as claimed in claim 2, wherein as a software application is distributed, an embedded identification code is added to the software, enabling tracking of the route of distribution.

5. A method as claimed in claim 2, wherein the link message is dispatched to one or more second mobile terminals when the application is run on the first terminal or at a point during operation of the program.

6. A method as claimed in claim 2, wherein the link is sent to one or a plurality of terminals, simultaneously or sequentially.

7. A method as claimed in claim 6, wherein the link is sent to one or more pre-stored contacts.

8. A method as claimed in claim 2, wherein JAR and JAD files are transmitted between the second terminal and server.

9. A method as claimed in claim 8, comprising sending a message to the server from the second terminal, causing the server to respond with a billing message, causing the terminal to respond and, if payment is received, causing the server to transmit, or enable transmission of the software to the terminal.

10. A mobile game distribution system allowing the user of one mobile terminal to transmit a software application to a further mobile terminal by means of the software application being adapted to cause or enable the first mobile terminal to transmit a message, containing a link to a location on a server which stores the software application or a related application, to one or more further mobile terminals.

11. A system as claimed in claim 10, wherein the link is transmitted at the time of running, or during operation of, the application.

12. A system as claimed in claim 10, wherein an option to transmit the link is generated at the time of running the application or during operation of the application.

13. A mobile game distribution system allowing the user of one mobile terminal to transmit a software application to a second mobile terminal by means of the application being adapted to cause or enable the first terminal to transmit a message to one or more second terminals enabling the application to be transmitted between the terminals.

14. A method of distributing software applications between mobile terminals, wherein ‘viral’ distribution is used.

15. A system substantially as hereinbefore described with reference to, and as illustrated by, the accompanying drawings.

16. A method substantially as hereinbefore described with reference to, and as illustrated by, any of the accompanying drawings.
